(19) United States
(12) Patent Application Publication
(10) Pub. No.: US 2026/0007274 A1
(43) Pub. Date: Jan. 8, 2026

(54) EXTENDED WAVE PATTERN HEAT TENT

(71) Applicant: W.C. BRADLEY CO., Columbus, GA (US)

(72) Inventors: Sleiman Abdallah, Columbus, GA (US); Ryan Sterritt, Auburn, AL (US); Bruce Roberts, Columbus, GA (US); Andy Krawchyk, Columbus, GA (US); Thomas A. Penner, Columbus, GA (US)

(21) Appl. No.: 19/259,961

(22) Filed: Jul. 3, 2025

Related U.S. Application Data
(60) Provisional application No. 63/667,495, filed on Jul. 3, 2024.

(51) Int. Cl. A47J 37/07

(52) U.S. Cl. CPC A47J 37/0786; A47J 37/0713

(57) ABSTRACT

A device for use in a gas cooking grill has a central peaked structure having a front end and a back end with a longitudinal ridge of a first height spanning from the front end to the back end, and first and second pluralities of lower peaked ridges extending laterally from both first and second sides of the central peaked structure with each individual peaked ridge of the first and second plurality of lower peaked ridges being separated by a valley therebetween. Each individual peaked ridge of the first and second plurality of lower peaked ridges has a height that is lower than the first height of the longitudinal ridge.

### CROSS-REFERENCE TO RELATED CASES

This application claims the benefit of U.S. provisional patent application Ser. No. 63/667,495, filed on Jul. 3, 2024, and incorporates such provisional application by reference into this disclosure as if fully set out at this point.

### FIELD OF THE INVENTION

The present disclosure relates to cooking appliances in general and, more particularly, to heat tents for gas cooking grills.

### BACKGROUND OF THE INVENTION

Existing outdoor gas grills usually utilize some form of steel barrier preventing a direct path between the burners and cooking surface. This part may be formed of stamped steel with a singular peak directly over the burner.

In operation, the barrier diverts grease drippings away from the flame source. However, heat from the flame may remain uneven at the cooking surface. Additionally, due to the nature of convective cooking, food cooked over such a barrier may become dry. This is because the grease is quickly evacuated away from the cook surface, and either combusts in the bottom of the firebox or drains to the grease cup (which needs to be consistently manually cleaned by the consumer). Evenness of temperature of the cook surface is also not promoted by such barriers. A more even cook surface (measured by standard deviation from the mean temperature) is a benefit to the consumer.

What is needed is a device, system, and method for addressing the above and related problems.

### SUMMARY OF THE INVENTION

The invention of the present disclosure, in another aspect thereof, comprises a device for use in a gas cooking grill having a central peaked structure having a front end and a back end with a longitudinal ridge of a first height spanning from the front end to the back end, and first and second pluralities of lower peaked ridges extending laterally from both first and second sides of the central peaked structure with each individual peaked ridge of the first and second plurality of lower peaked ridges being separated by a valley therebetween. Each individual peaked ridge of the first and second plurality of lower peaked ridges has a height that is lower than the first height of the longitudinal ridge.

The device may have a plurality of openings defined in the valley between adjacent lower peaked ridges. The first and second pluralities of lower peaked ridges may comprise at least two lower peaked ridges. The central peaked structure and the first and second plurality of lower peaked ridges may be formed from a plane of material bent at least nine times.

A length of the central peaked structure may be greater than a length of each of the lower peaked ridges. A length of individual peaked ridges of the first and second plurality of lower peaked ridges may differ.

In various embodiments, the central peaked structure and first and second pluralities of lower peaked ridges may be formed from a continuous plane of material bent 9 times, 11 times, or 19 times.

In some embodiments, the central peaked structure and first and second pluralities of lower peaked ridges are formed from a continuous plane of material having a 90 degree bend corresponding to the central peaked structure and a plurality of 75 degree bends corresponding to the first and second pluralities of lower peaked ridges.

The invention of the present disclosure, in another aspect thereof, comprises a system for use in a gas cooking grill. The system has a plurality of heat tents each forming a central longitudinal ridge having a height greater than first and second flanking lateral extensions forming a plurality of lower peaks parallel to the central longitudinal ridge. Each one of the plurality of heat tents is situated in a fire box of the gas cooking grill such that the respective central longitudinal ridge is parallel to and above a tubular gas burner in the fire box.

In some embodiments, each of the plurality of heat tents is spaced apart from an adjacent one of the plurality of heat tents by a predetermined distance. In various embodiments, the predetermined distance is greater than about 1.9 mm or less than about 16.7 mm.

Each of the plurality of heat tents may be formed from a plane of material bent at least 9 times to form the central longitudinal ridge and the first and second flanking lateral extensions. The central longitudinal ridge may have a length greater than the first and second lateral extensions.

The invention of the present disclosure, in another aspect thereof, comprises a cooking grill having a plurality of parallel burners in a fire box and below a cooking surface, and a plurality of heat tents interposing the parallel burners and the cooking surface. Each of the plurality of heat tents comprises a central peaked structure extending between a front end of the fire box and a back end of the firebox, and first and second side extensions extending laterally from the central peaked structure and defining a plurality of ridges parallel to the central peaked structure. The central peaked structure is a first, shorter distance from the cooking surface and the pluralities of ridges of the first and second side extensions are a second, longer distance from the cooking surface. The central peaked structure of each of the plurality of heat tents is aligned substantially centrally and parallel with one of the plurality of parallel burners.

In some cases the central peaked structure of each of the plurality of heat tents is longer, longitudinal, than the respective side extensions and rests on front and back support ledges in the fire box. The first and second side extensions of each of the plurality of heat tents may define openings between their respective pluralities of ridges. The plurality of heat tents are retained in the firebox such that a predetermined gap is maintained between adjacent heat tents.

### BRIEF DESCRIPTION OF THE DRAWINGS

FIG. 1 is a perspective view of one embodiment of a heat tent according to the present disclosure.

FIG. 2 is cutaway perspective view of a plurality of heat tents according to the present disclosure installed into a fire box of a gas grill interposing the burners and the cooking surface.

FIG. 3 is an overhead view of a plurality of heat tents according to the present disclosure installed into a fire box of a gas grill.

FIG. 4A is an overhead view of the heat tent of FIG. 1 with exemplary dimensions shown.

FIG. 4B is an end view of the heat tent of FIG. 1 with exemplary dimensions shown.

FIG. 5A is a perspective view of another embodiment of a heat tent according to the present disclosure.

FIG. 5B is an overhead view of the heat tent of FIG. 5A with exemplary dimensions shown.

FIG. 5C is an end view of the heat tent of FIG. 5A with exemplary dimensions shown.

FIG. 6A is a perspective view of another embodiment of a heat tent according to the present disclosure.

FIG. 6B is an overhead view of the heat tent of FIG. 6A with exemplary dimensions shown.

FIG. 6C is an end view of the heat tent of FIG. 6A with exemplary dimensions shown.

FIG. 7 is an overheard closeup view of plurality of heat tents according to the present disclosure installed into a cooking grill.

### DETAILED DESCRIPTION OF THE PREFERRED EMBODIMENTS

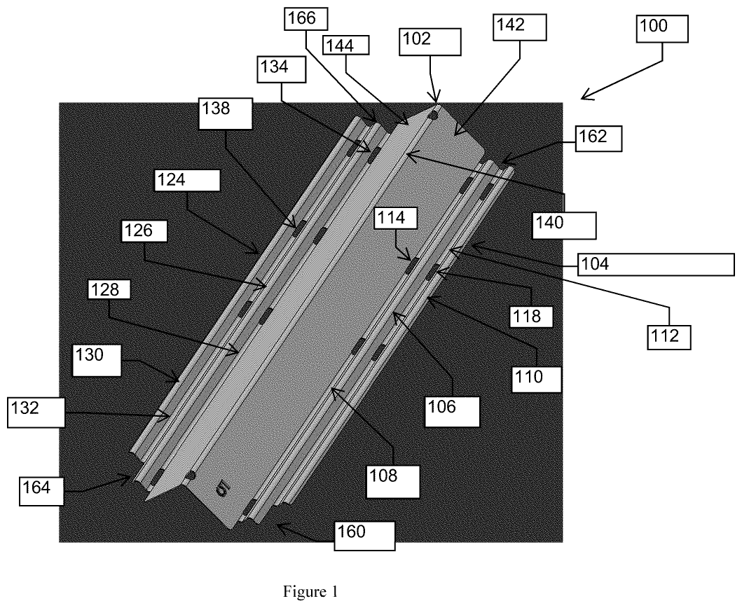

Referring now to FIG. 1 is a perspective view of one embodiment of a heat tent 100 according to the present disclosure is shown. The heat tent is one of various embodiments according to embodiments of the present disclosure describing, an extended wave pattern heat tent. As shown, the heat tent 100 comprises a central peaked structure 102 flanked by opposed extended wave portions 104, 124. The central peaked structure 102 may have opposed walls 142, 144 descending from a longitudinal peak 140. The opposed walls 142, 144 may be planar and may descend from the peak 140 to the extended wave portions 104, 124, respectively.

The extended wave portions 104, 124 may extend laterally from a bottom portion of the walls 142, 144 respectively. The extended wave portion 104 may comprise a plurality of peaks 106, 110 with a valley 108 between the wall 142 and peak 106, and a valley 112 between peaks 106, 110. Thus a laterally extending repeated wave pattern is formed. The extended wave portion 124 may comprise a plurality of peaks 126, 130 with a valley 128 between the wall 144 and the peak 126 and a valley 132 between the peaks 126, 130.

Within the valley 108, one or more openings 114 may be defined to allow drainage. Drainage openings 118 may be defined within valley 112. The valleys 128, 132 may define one or more openings 134, 138, respectively, in a similar fashion.

The extended wave portions 104, 124 may not extend to the same length as the central peaked structure 102. Thus rebated portions 160, 162 may be defined at respective ends of the extended wave portion 104. Rebated portions 164, 166 may be defined at respective ends of the extended wave portion 124. The extended wave portions 104, 124 may be mirrors of one another such that the entire heat tent 100 is mirrored with respect to the longitudinal peak 140.

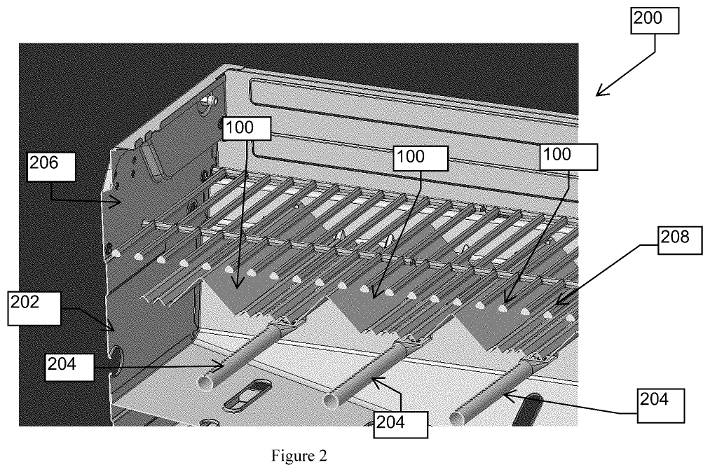

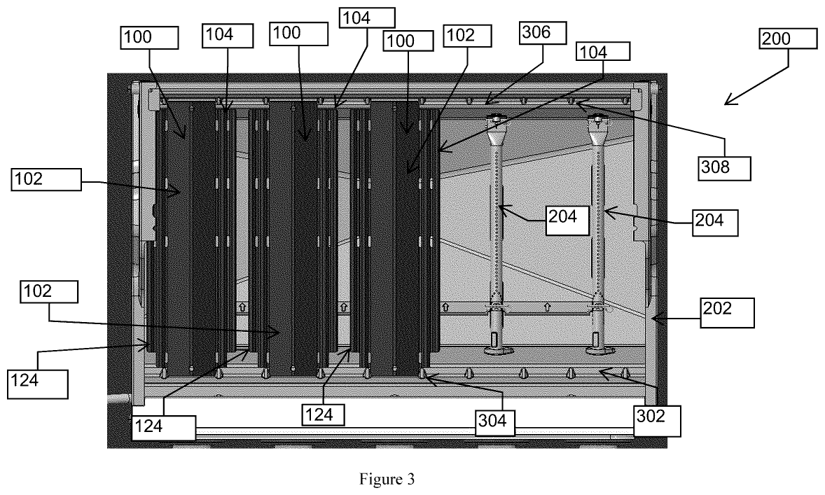

Referring now to FIG. 2 is cutaway perspective view of a plurality of heat tents 100 according to the present disclosure installed into a fire box 202 of a gas grill 200 interposing gas burners 204 and a cooking surface 208 is shown. FIG. 3 provides an overhead view of the same but with some of the heat tents 100 removed for illustrative purposes.

The heat tents 100 may be placed into the firebox 202 such that the central peaked structures 102 are each centered over one of a number of tubular burners 204 in the firebox. The heat tents 100 may be longitudinally aligned and parallel with the tubular burners 204 with the respective extended wave portions 104, 124 extending toward one another where there are adjacent heat tents 100.

In some embodiments, the heat tents 100 may be centered over a straight portion of a burner with an overall more complex shape than shown. Further, not every burner 204 is covered by a heat tent 100 in every embodiment. For example, in some cases, some burners may be used to heat griddles where a heat tent may not be necessary. However, coverage can be provided over each of the burners as well as most of the firebox 202 below the cooking surface 208. The cooking surface 208 may be a grate, a griddle, or other cooking surface known to the art.

In some embodiments, the heat tents are installed by being supported on a front support surface or ledge 304 and/or a back support surface or ledge 306. These may be integrally formed with the fire box 202 or otherwise affixed thereto. Stops or bosses 304, 308 may be installed along the respective support ledges 304, 306 to aid in lateral location of the heat tents.

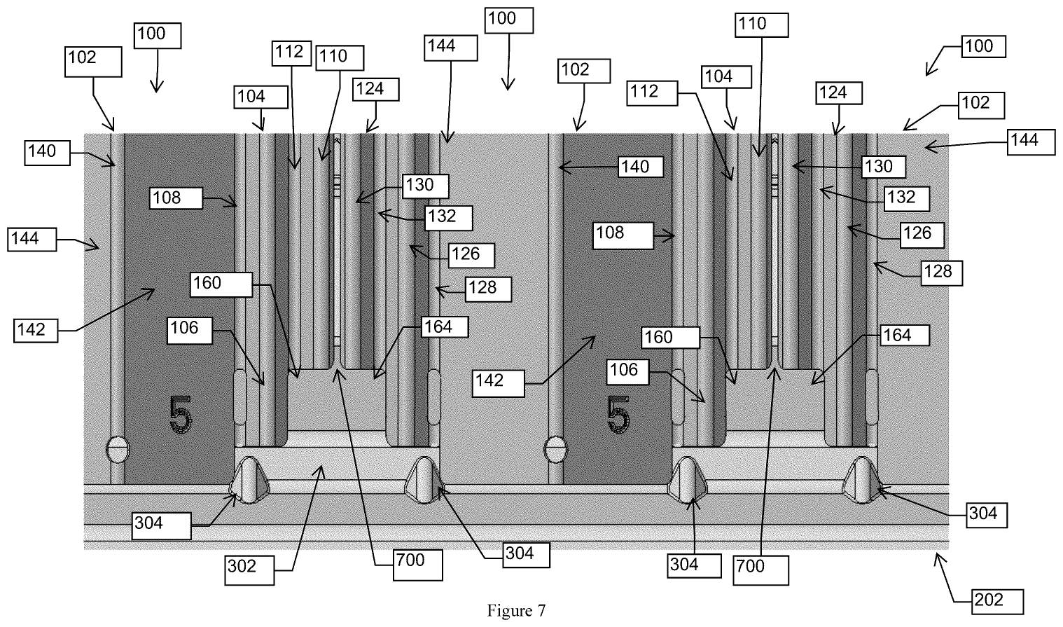

As more easily seen in FIG. 7, bosses 304, 308 may limit the lateral movement of the central peaked structures 102 and therefore the heat tents 100 as well as retain the heat tents 100 with a fixed and predetermined spacing or gap 700 therebetween. In various embodiments, the gap 700 may be from 1.9 mm to 16.7 mm; such as, for example 1.9 mm, 3.1 mm, 3.3 mm, or 16.7 mm, or within 5% of these values.

It can also be seen that the rebated portions 160, 162, 164, 166 may not engage the ledges 304, 306 on a top thereof but may sit further down into the fire box 202 leaving lower portions of the walls 142, 144 to engage upper portions of the ledges 304, 306. Upright portions of the ledges 304, 306 may engaged at the rebated portions 160, 162 and 164, 166, respectively, to help in front to back location or securement of the heat tents 100. As can be seen, the peaks 126 and 130 may have a differing length from one another. Opposite peaks 106 and 110 may also differ. Thus the rebated portions 160, 164 may have a staggered arrangement. This arrangement may be configured to adjust fluid flow or combustion product flow. A similar arrangement may be provided at the opposite back end (e.g., at rebated portions 162, 166).

The gaps 700 may be in the positions laterally most distant from the burners 204. In some embodiments, an arrangement or pattern of holes or perforations 118 and 138 in the heat tents 100 allows for flue gas to move up through the firebox 202, and allows excessive grease to evacuate to the bottom of the firebox. Spacing or gaps 700 between heat tents and the perforations 118, 138 also allow for radiative and convective heating effects to be controlled to promote even cooking temperatures on the grate or cooking surface 208.

Due to the increased mass and a layer of coverage between the heat source (e.g., burners 204) and cook surface 208, some amount of radiative heating to the cook surface 208 is generated. In combination with convective heating from the flue gas, a more even temperature profile is generated on the cook surface 208 compared to traditional heat barriers. Heat tents 100 of the present disclosure also act to vaporize more grease than traditional heat barriers. This results in juicier food and limits the amount of grease cup cleaning for the consumer. The further embodiments of heat tents described below function similarly and provide similar or identical advantages.

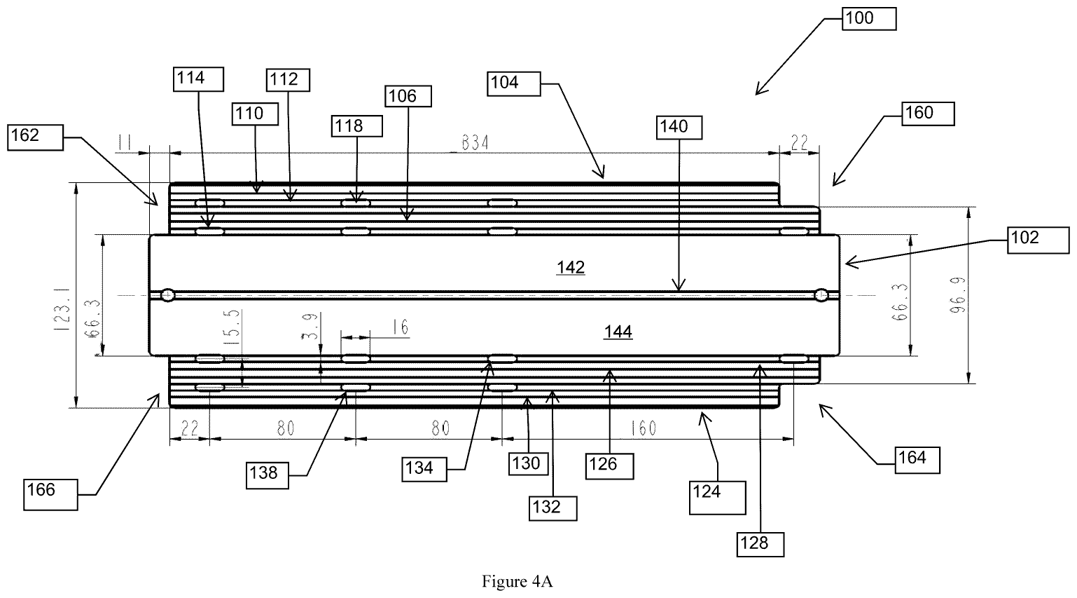

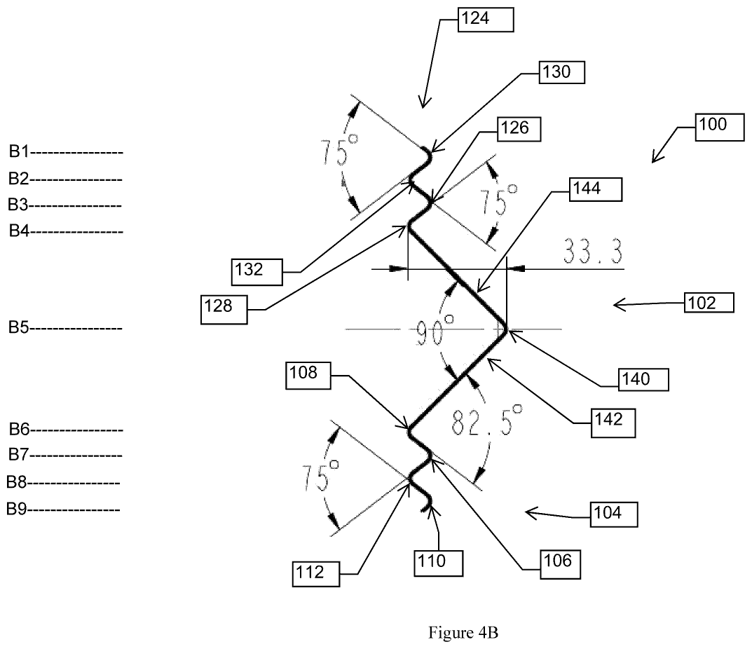

Referring now to FIG. 4A, an overhead view of the heat tent 100 of FIG. 1 with exemplary dimensions shown. FIG. 4B is an end view of the heat tent 100 of FIG. 1 with exemplary dimensions shown. The dimensions shown may be in millimeters. Other units may be used if scaled proportionately. Furthermore, other dimensions altogether may be used in different embodiments with varying degrees of effect.

With particular reference to FIG. 4B, it can be seen that the heat tent 100 may be formed from a single sheet or plane of material that has been bent nine times to achieve the structure described herein. An exemplary angle between the walls 142, 144 of 90 degrees may be utilized. An angle of 82.5 degrees may form valleys 108, 128 while angles of 75 degrees may form valleys 112, 132 and peaks 106, 110, 126, 130. In other embodiments, angles different from those shown may be employed with varying degrees of effect.

A height of the central peaked structure 102 may be greater than a height of the respective peaks 106, 110, 126, 130 and valleys of the 108, 112, 128, 132 of the extended wave portions 104, 124. Thus, when the heat tent 100 is installed, the central peaked structure may rise nearer to the cooking surface 108 and further from the burner 204 that the respective peaks 106, 110, 126, 130 and valleys of the 108, 112, 128, 132 of the extended wave portions 104, 124.

The heat tent 100 may be formed by stamping, casting, machining or another process depending upon material used. The heat tent 100 may comprise a heat resistant steel another suitable alloy or material. Coatings may be utilized where appropriate but are not utilized in all cases.

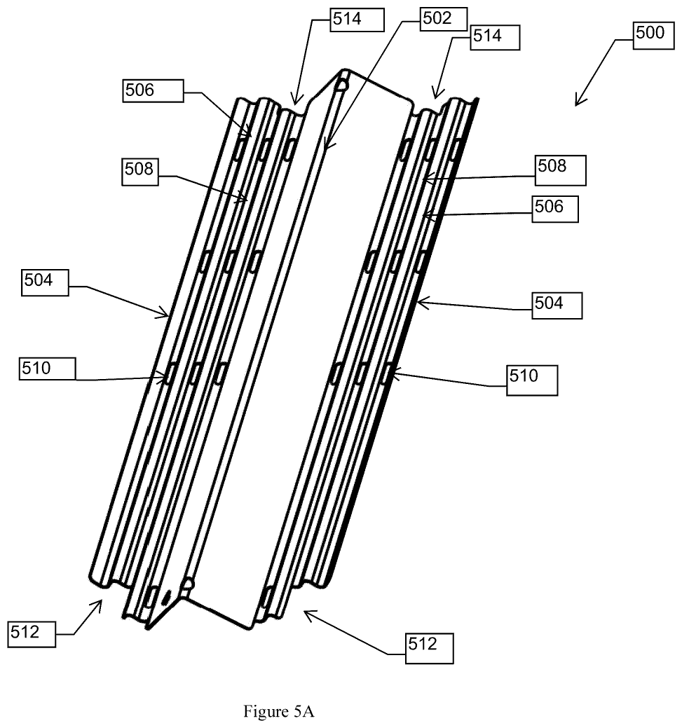

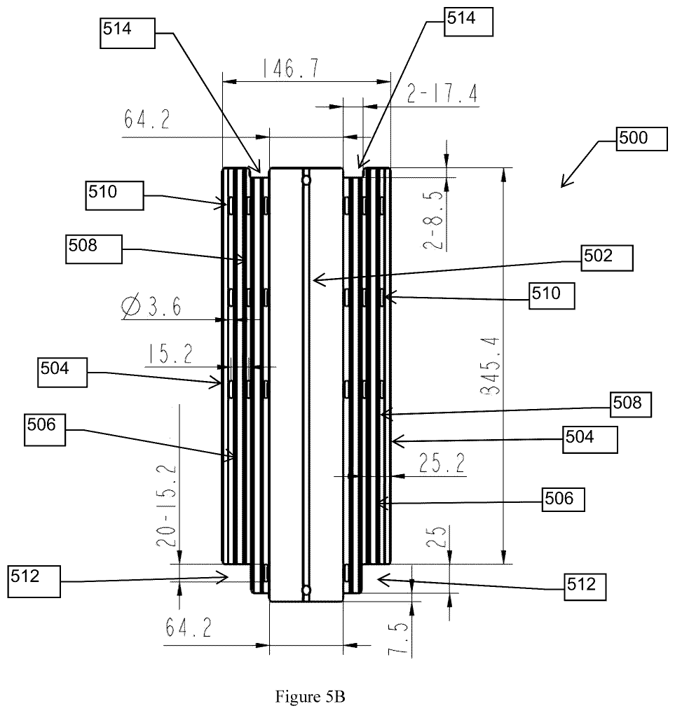

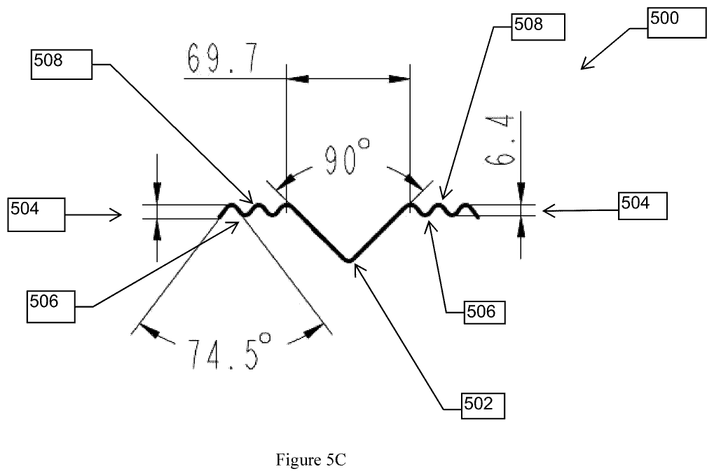

Referring now to FIG. 5A is a perspective view of another embodiment of a heat tent 500 according to the present disclosure is shown. The heat tent 500 comprises a central peaked structure 502 of similar or identical build to the central peaked structure 102 of the heat tent 100. Extending laterally from the central peaked structure 502 are a pair of opposed extended wave portions 504. These are similar to extended wave portions 104, 124 of heat tent 100 except for having a greater number of peaks 506 and valleys 508, front rebated portions 512, and back rebated portions 514. Perforations or openings may be defined within the valleys 508.

An overhead view of the heat tent 500 is shown in FIG. 5B with exemplary dimensions. Units are in millimeters but other units may be used and all dimensions scaled accordingly.

FIG. 5C is an end view of the heat tent 500 of FIG. 5A with exemplary dimensions and angles shown. Dimensions and angles may be altered with varying degrees of effect. In some embodiments, the total height of the central peaked structure, and therefore the tent 500, is 32 mm or about 32 mm.

It can be seen that it is possible to construct the heat tent 500 from a single sheet or plane of material having eleven bends therein at the angles shown (or other angles).

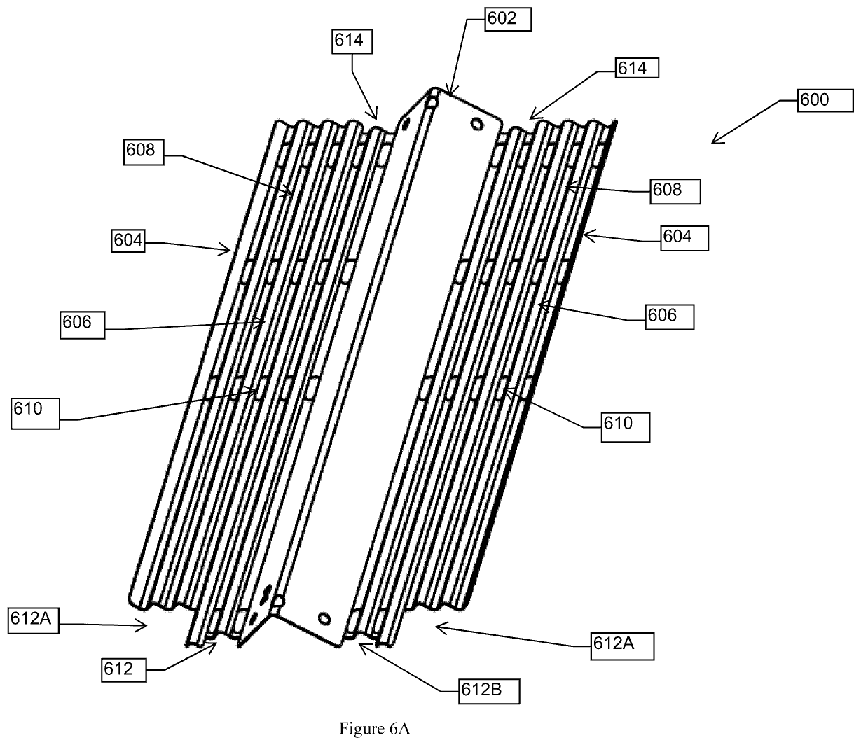

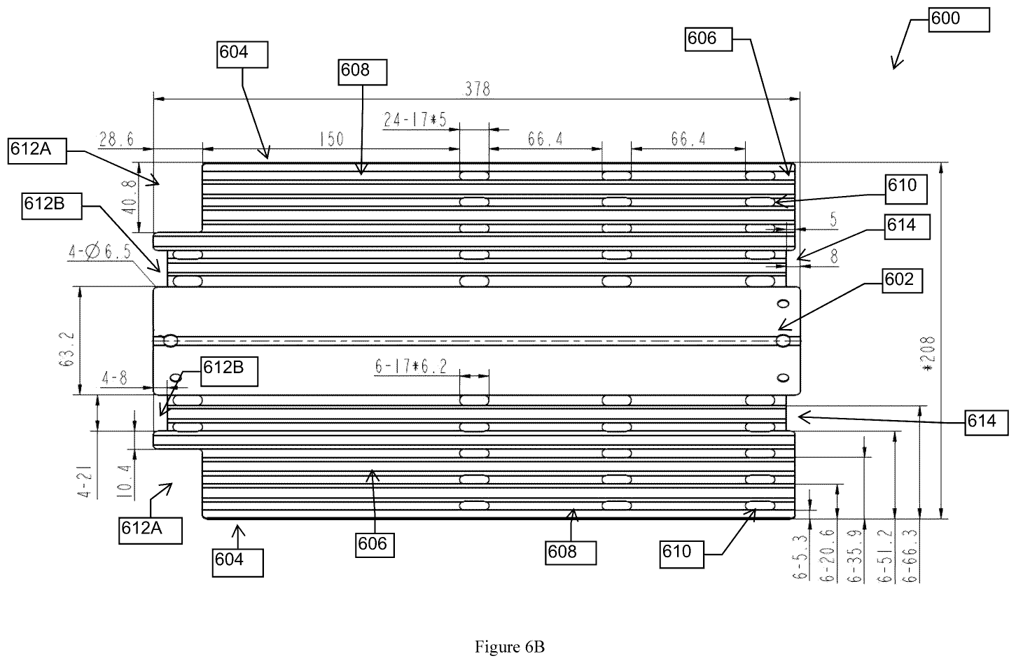

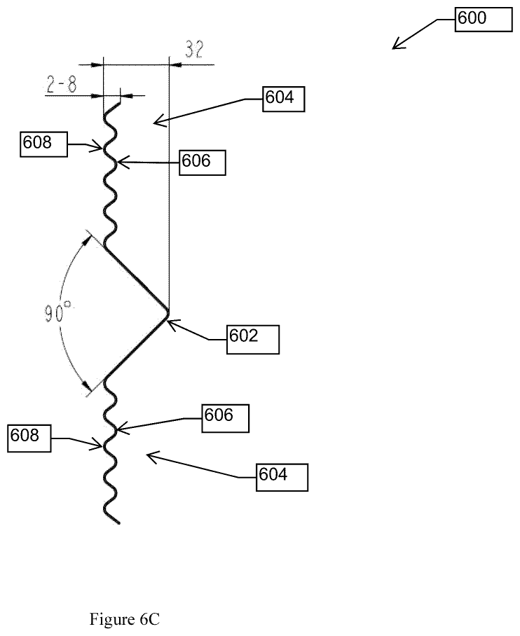

Referring now to FIG. 6A, a perspective view of another embodiment of a heat tent 600 according to the present disclosure is shown. The heat tent 600 comprises a central peaked structure 602 of similar or identical build to the central peaked structure 102 of the heat tent 100. Extending laterally from the central peaked structure 602 are a pair of opposed extended wave portions 604. These are similar to extended wave portions 104, 124 of heat tent 100 except for having a greater number of peaks 606 and valleys 608, front rebated portions 614, and back rebated portions 614. Perforations or openings may be defined within the valleys 608.

An overhead view of the heat tent 600 is shown in FIG. 6B with exemplary dimensions. Units are in millimeters but other units may be used and all dimensions scaled accordingly.

FIG. 6C is an end view of the heat tent 600 of FIG. 6A with exemplary dimensions and angles shown. Dimensions and angles may be altered with varying degrees of effect. It can be seen that it is possible to construct the heat tent 500 from a single sheet or plane of material having nineteen bends therein at the angles shown (or other angles).

The heat tents 500, 600 may be utilized in a similar manner as the heat tent 100 described above. The respective rebated portions 512, 514, 612, 614 may be particularly configured to properly locate the heat tents 500, 600 both laterally and longitudinally, by interacting with ledges 302, 306 and or/bosses 304, 308. Rebated portions 512, 514, 612, 614 may be defined so as to control gas or fluid flow as well as to provide proper overall elevation of the respective heat tents 500,600 and to provide clearance for other items within the fire box 202.

Spacing between heat tents 100, 500, 600 and other embodiments according to the present disclosure may vary from zero (e.g., adjacent heat tents in contact with one another) to 16.7 mm or more. In some embodiments, spacing between adjacent heat tents 100/500/600 and other embodiments according to the present disclosure is uniform within the fire box. In other embodiments, spacing between adjacent heat tents 100/500/600 and other embodiments according to the present disclosure can vary. In some embodiments, every heat tent 100/500/600 and other embodiments according to the present disclosure is dimensionally substantially identical to the others. In other embodiments, the shape and/or dimensions of the heat tents 100/500/600 and other embodiments according to the present disclosure in a single fire box 202 may vary.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A device for use in a gas cooking grill comprising:
a central peaked structure having a front end and a back end with a longitudinal ridge of a first height spanning from the front end to the back end;
first and second pluralities of lower peaked ridges extending laterally from both first and second sides of the central peaked structure with each individual peaked ridge of the first and second plurality of lower peaked ridges being separated by a valley therebetween;
wherein each individual peaked ridge of the first and second plurality of lower peaked ridges has a height that is lower than the first height of the longitudinal ridge.

2. The device of claim 1, further comprising a plurality of opening defined in the valley between adjacent lower peaked ridges.

3. The device of claim 1, wherein the first and second pluralities of lower peaked ridges comprises at least two lower peaked ridges.

4. The device of claim 3, wherein the central peaked structure and the first and second plurality of lower peaked ridges are formed from a plane of material bent at least nine times.

5. The device of claim 1, wherein a length of the central peaked structure is greater than a length of each of the lower peaked ridges.

6. The device of claim 5, wherein a length of individual peaked ridge of the first and second plurality of lower peaked ridges differs.

7. The device of claim 1, wherein the central peaked structure and first and second pluralities of lower peaked ridges are formed from a continuous plane of material bent 9 times.

8. The device of claim 1, wherein the central peaked structure and first and second pluralities of lower peaked ridges are formed from a continuous plane of material bent 11 times.

9. The device of claim 1, wherein the central peaked structure and first and second pluralities of lower peaked ridges are formed from a continuous plane of material bent 19 times.

10. The device of claim 1, wherein the central peaked structure and first and second pluralities of lower peaked ridges are formed from a continuous plane of material having a 90 degree bend corresponding to the central peaked structure and a plurality of 75 degree bends corresponding to the first and second pluralities of lower peaked ridges.

11. A system for use in a gas cooking grill comprising:
a plurality of heat tents each forming a central longitudinal ridge having a height greater than first and second flanking lateral extensions forming a plurality of lower peaks parallel to the central longitudinal ridge;
wherein each one of the plurality of heat tents is situated in a fire box of the gas cooking grill such that the respective central longitudinal ridge is parallel to and above a tubular gas burner in the fire box.

12. The system of claim 11, each of the plurality of heat tents is spaced apart from an adjacent one of the plurality of heat tents by a predetermined distance.

13. The system of claim 11, wherein the predetermined distance is greater than about 1.9 mm.

14. The system of claim 11, wherein the predetermined distance is less than about 16.7 mm.

15. The system of claim 11, wherein each of the plurality of heat tents is formed from a plane of material bent at least 9 times to form the central longitudinal ridge and the first and second flanking lateral extensions.

16. The system of claim 11, wherein the central longitudinal ridge has a length greater than the first and second lateral extensions.

17. A cooking grill comprising:
a plurality of parallel burners in a fire box and below a cooking surface; and
a plurality of heat tents interposing the parallel burners and the cooking surface;
wherein each of the plurality of heat tents comprises:
a central peaked structure extending between a front end of the fire box and a back end of the firebox; and
first and second side extensions extending laterally from the central peaked structure and defining a plurality of ridges parallel to the central peaked structure;
wherein the central peaked structure is a first, shorter distance from the cooking surface and the pluralities of ridges of the first and second side extensions are a second, longer distance from the cooking surface; and
wherein the central peaked structure of each of the plurality of heat tents is aligned substantially centrally and parallel with one of the plurality of parallel burners.

18. The cooking grill of claim 17, wherein the central peaked structure of each of the plurality of heat tents is longer, longitudinal, than the respective side extensions and rests on front and back support ledges in the fire box.

19. The cooking grill of claim 17, wherein the first and second side extensions of each of the plurality of heat tents defines opening between their respective pluralities of ridges.

20. The cooking grill of claim 17, wherein the plurality of heat tents are retained in the firebox such that a predetermined gap is maintained between adjacent heat tents.
